(19) United States
(12) Patent Application Publication
(10) Pub. No.: US 2005/0143869 A1
(43) Pub. Date: Jun. 30, 2005

(54) Usability evaluation system for driver information system of vehicles

(76) Inventors: Jin Ho Park, Seoul (KR); Peom Park, Suwon-city (KR); Insup Baek, Suwon-city (KR); Sung Hyun Kang, Chuncheon-city (KR)

Correspondence Address: MORGAN, LEWIS & BOCKIUS LLP (SF), 2 PALO ALTO SQUARE, PALO ALTO, CA, 94306, US

(21) Appl. No.: 11/021,835

(22) Filed: Dec. 22, 2004

(30) Foreign Application Priority Data
Dec. 30, 2003 (KR) 10-2003-0100757

(51) Int. Cl. G06F 7/00

(52) U.S. Cl. 701/1; 701/35

(57) ABSTRACT

The usability evaluation system for a driver information system includes a database, a driver information system realization portion, and a user's evaluation data gathering portion. The driver information system realization portion realizes a prototype driver information system and detects a user's manipulation reaction data while a user operates the driver information system. This portion converts the detected user's manipulation reaction data to data for a usability evaluation and automatically stores the converted data in the database. The user's evaluation data gathering portion gathers a user's objective evaluation data for the realized driver information system, and it converts the gathered user's objective evaluation data to data for a usability evaluation and automatically stores the converted data to the database.

### CROSS REFERENCE TO RELATED APPLICATION

This application claims priority to Korean Application No. 10-2003-0100757, filed on Dec. 30, 2003, the disclosure of which is incorporated herein by reference.

### TECHNICAL FIELD OF THE INVENTION

The present invention relates to a driver information system for vehicles, and more particularly, to a system for evaluating usability of the driver information system.

### BACKGROUND OF THE INVENTION

Generally, usability evaluation technology has a process of preparing the base of design elements that are easily and conveniently used by a user on the basis of evaluations of characteristics of using environment and system of users such as designs of products or system, analysis of user's demand, analysis of work, and analysis of situation, and a process of developing a prototype according to the prepared design elements. Such analysis technologies are used as a subject or object method for extracting human characteristics, or as quantitative or qualitative evaluation methods.

However, most methods that are used for a usability evaluation are passive and not real-time methods, and generally include post-analysis by processing data after evaluation.

In addition, because users' subjective evaluations, such as question papers, are generally performed after terminating a user test of the products or systems, they may miss a presence. There is also a problem that a user's prompt opinions or accurate claims at the time of a usability test cannot be reflected. In particular, in a circumstance having mobility characteristics such as with a vehicle, most tests are performed by establishing a virtual experiment environment, and a long time and high cost are needed for establishing such a testing environment.

Further, information devices inside a vehicle, such as an audio and video (AV) device, a navigation device, a telematics terminal, and a portable wireless phone, have been separately installed or mounted in vehicles. Because such information devices have different types of interface, drivers must learn how to use such devices. Manipulation of such devices while driving a vehicle may cause an accident.

In addition, because user interfaces that allow users to use various devices easily and conveniently are also designed according to characteristics of each device, without considering the moving environments of vehicles, driving characteristics of drivers, or consistent use environments, it is difficult to achieve a design or an evaluation of a user interface that is suitable for environments of a user or a vehicle.

In addition, although various ergonomic evaluation methods can be applicable for the user interface evaluation method for the information devices, most evaluation methods utilize subject analysis methods such as a user demand analysis through question papers and a usability test through work analysis prototypes, and various human body measurement devices. These usability evaluation methods are generally performed for different objects and in different manners. They also require long testing periods and cannot provide a real-time analysis, thereby not being efficient.

An information system that is used for a vehicle having special environments must be designed in accordance with characteristics of a driver's driving work, using environments of various applications having various functions must have an interface of a consistent and common type because there is a tendency that information devices of a vehicle are integrated in one device. However, the conventional usability evaluation methods are not suitable for evaluating such integrated information devices or a consistent interface, and have a problem that they cannot effectively obtain driver's use characteristics occurring during a real driving environment.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention provides a system for evaluating usability of a driver information system in real time and multi-dimensionally. An exemplary usability evaluation system for a driver information system according to an embodiment of the present invention includes: a database, a driver information system realization portion, and a user's evaluation data gathering portion. The driver information system realization portion realizes a prototype driver information system and detects a user's manipulation reaction data while a user operates the driver information system. This portion then converts the detected user's manipulation reaction data to data for a usability evaluation and automatically stores the converted data in the database. The user's evaluation data gathering portion gathers a user's objective evaluation data for the realized driver information system, converts the gathered user's objective evaluation data to data for a usability evaluation and automatically stores the converted data to the database.

The driver information system realization portion may include a computer for executing an application program that provides a user interface for realizing the driver information system, an output device for outputting the user interface provided by the application program, and an input device for providing functions for operating the outputted user interface.

The driver information system realization portion may further include a global positioning system (GPS) receiver configured to be linked to a position information providing service of the application program, a wireless communication terminal for a wireless communication, a voice input/output device for a voice interface of the application program, and a voice recognition device for recognizing a user's voice received from the voice input/output device.

In another embodiment, the usability evaluation system further includes a photographing part for photographing a user's action for manipulating the driver information system and the driver information system to obtain data for analyzing a user's action for manipulating the driver information system, and a body signal detecting part for detecting a body signal information of the user while operating the driver information system. The photographing part may photograph a user of the driver information system, the driver information system, and a vehicle front portion, and the body signal detecting part may detect a brain wave of the user of the driver information system, an eyeball movement of the user, and a heart movement of the user.

The user's objective evaluation data may include data for a user's mental workload while operating the realized driver information system; data for a user's complaint and claim for the realized driver information system; data for a user's emotional feeling for the realized driver information system; and data for a user's requirement for a new design or a new function.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic diagram of a usability evaluation system for an information system of a vehicle according to an embodiment of the present invention; and

FIG. 2 is a flowchart showing operations of a usability evaluation system for an information system of a vehicle according to an embodiment of the present invention.

### DETAILED DESCRIPTION OF THE EMBODIMENTS

Hereinafter, embodiments of the present invention will be described in detail with reference to the accompanying drawings.

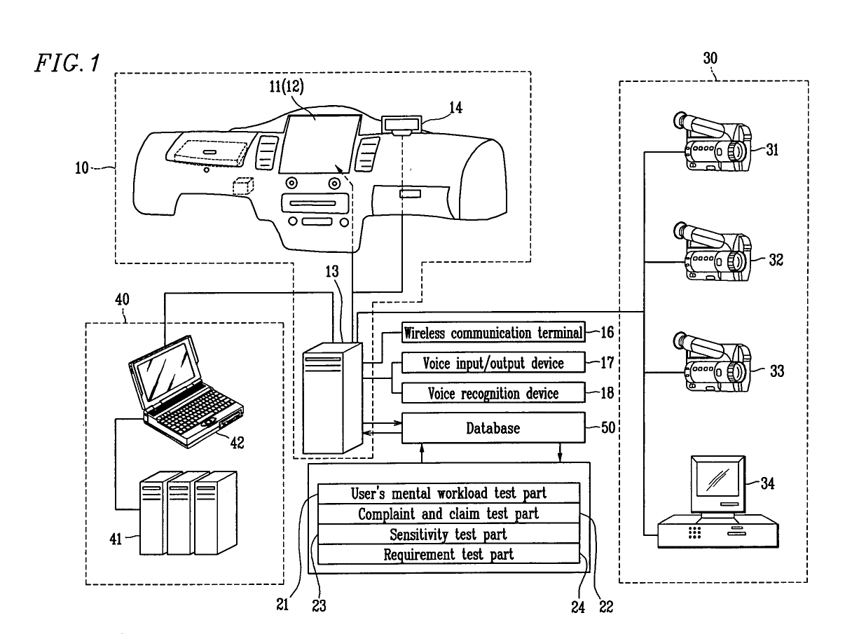

A schematic diagram of a usability evaluation system for a driver information system of a vehicle according to an embodiment of the present invention is shown in FIG. 1.

A usability evaluation system for an information system of a vehicle according to an embodiment of the present invention is a system for evaluating and analyzing a user's (or driver's) usability for a next-generation driver information system (DIS) that is realized as a single display and input device by integrating various information systems such as a radio device, a compact disc (CD) player, a digital video disc (DVD) player, a navigation device, a television (TV), an internet device, a multi-media device, and a communication terminal.

With reference to FIG. 1, a usability evaluation system for a driver information system according to an embodiment of the present invention includes a driver information system realization portion 10 for realizing a prototype driver information system, a user's evaluation data gathering portion for gathering a user's objective evaluation data for the realized driver information system, and a database 50.

The driver information system realization portion 10 detects a user's manipulation reaction data while a user operates the realized driver information system, and converts the detected user's manipulation reaction data to data for a usability evaluation. The driver information system realization portion 10 also automatically stores the converted data in the database 50. The user's manipulation reaction data may include various data for a user's reaction such as a reaction time for executing a specific function of the driver information system, a success or a failure of executing a specific function, and a manipulation sequence.

The user's evaluation data gathering portion converts the gathered user's objective evaluation data into converted data for a usability evaluation and automatically stores the converted data to the database 50.

In one embodiment, with reference again to FIG. 1, the driver information system realization portion 10 may includes a computer 13 for executing an application program that provides a user interface for realizing the driver information system, an output device 11 for outputting the user interface provided by the application program, and an input device 12 for providing functions for operating the outputted user interface. The computer 13 may include a processor, a memory, and related hardware and software, and is activated by the application program for executing instructions for realizing the prototype driver information system, detecting a user's manipulation reaction data while a user operates the realized driver information system, converting the detected user's manipulation reaction data to data for a usability evaluation, and automatically storing the converted data in the database 50. As is obvious in the art, such an application program may be stored in the memory.

The output device 11 may be a liquid crystal display (LCD) device or other display device that is able to display images to realize the driver information system corresponding to signals input from the computer 13. The input device 12 may be a touch screen or other suitable device to receive a user's manipulation of the driver information system displayed on the output device 11. As is obvious in the art, the output device 11 and the input device 12 may be integrated to one unit, as shown in FIG. 1.

The driver information system realization portion 10 may further include a global positioning system (GPS) receiver 14, a wireless communication terminal 16, a voice input/output device 17, and a voice recognition device 18.

The global positioning system (GPS) receiver 14 is configured to be linked to a position information providing service of the application program that is executed by the computer 13.

The wireless communication terminal 16 is provided for wireless communication. A conventional wireless communication terminal can be used for the wireless communication terminal 16.

The voice input/output device 17 provides a voice interface of the application program, and the voice recognition device 18 recognizes a user's voice command received from the voice input/output device 17. The voice input/output device 17 may include a microphone as a voice input device and a speaker as a voice output device.

As explained above, the driver information system realization portion 10 realizes the prototype driver information system, detects the user's manipulation reaction data during execution of various functions of the realized driver information system, converts the detected manipulation reaction data to data for a usability evaluation, and stores the converted data to the database 50, by executing the application program.

The user's objective evaluation data gathered by the user's evaluation data gathering portion 20 may include data for a user's mental workload while operating the realized driver information system, data for a user's complaint and claim for the realized driver information system, data for a user's emotional feeling for the realized driver information system, and data for a user's requirement for a new design or a new function. For example, the user's evaluation data gathering portion 20 may be realized by an evaluation program, and the evaluation program may, as shown in FIG. 1, include: a user's mental workload test part 21 for testing the user's mental workload; a complaint and claim test part 22 for testing the user's complaint and claim for the realized driver information system; a sensitivity test part 23 for testing the user's emotional feelings such as easiness, complexity, and confusion; and a requirement test part 24 for a new design or a new function that is required by the user.

In a further embodiment, the usability evaluation system may further comprise a photographing part 30 and body signal detecting part 40. The photographing part 30 photographs a user's action for manipulating the realized driver information system to obtain data for analyzing a user's action for manipulating the realized driver information system. More particularly, the photographing part 30 photographs (including video) a user of the driver information system, the driver information system, and the front portion of the vehicle. Such photographed images can be used for an analysis of a user's manipulation of the realized driver information system. For example, as shown in FIG. 1, the photographing part 30 may include a plurality of cameras 31, 32, and 33. In addition, the photographing part 30 may further comprise a four-division detector and regenerator 34 for effectively controlling operations of the cameras.

In some embodiments, the camera 31 photographs a vehicle front portion in a driving direction of a vehicle, the camera 32 photographs a user (e.g., a face and an upper part of the body of the user) who operates the realized driver information system, and the camera 33 photographs the realized driver information system itself, i.e., the output device 11 and the input device 12.

The body signal detecting part 40 detects a body signal information of the user while operating the realized driver information system. In one embodiment, the body signal detecting part 40 may detect a brain wave of the user, an eyeball movement of the user, and heart rate of the user. That is, the body signal detecting part 40 detects physiological load and stress in response to manipulations to operate various functions of the realized driver information system.

With reference again to FIG. 1, the body signal detecting part 40 may include a body signal detecting device 41 for detecting body signals of the user and a computer 42 for analyzing the detected body signals. The body signal detecting device 41 may include a brain wave detector (EEG) for detecting a brain wave, an eyeball motion detector (EOG) for detecting an eyeball motion, and a heart rate detector (ECG) for detecting heart rate, and such detectors can be realized by programs.

Additionally, the body signal detecting device 41 may further include surface electrode components that are attached to a skin of a driver to receive raw body signals. The computer 42 may include an analysis program for analyzing the detected body signal, and the analysis program may convert the detected body signals to a frequency domain and analyze the converted signal.

In one embodiment, an operation of the body signal detecting part 40 is synchronized to the operation of the application program that realizes the prototype driver information system. Accordingly, the body signals a time which is connected to a time the manipulation of the driver information system can be obtained, so that reliability of the usability evaluation can be improved.

Consequently, the user's manipulation reaction data is detected in real time during the user's operation of the realized driver information system while a vehicle to which the usability evaluation system according to an embodiment of the present invention is installed is running. The detected user's manipulation reaction data is converted to data for a usability evaluation, and then is automatically stored in the database 50. The user's objective evaluation data is gathered by the user's evaluation data gathering portion 20 once driving of the vehicle is completed. The data is converted to data for a suitability evaluation and is then automatically stored in the database 50. At this time, the user's manipulation reaction data and the user's evaluation data are preferably converted by a preset query of the database 50.

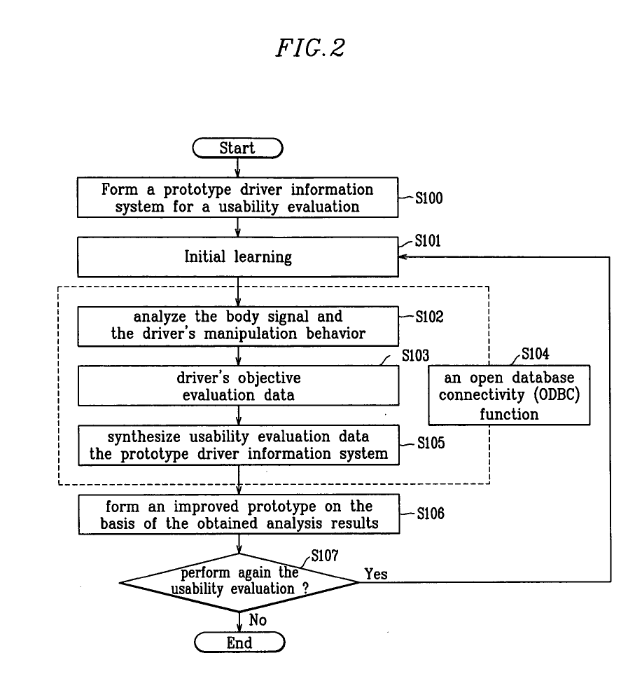

In FIG. 2, a flowchart showing operations of a usability evaluation system for an information system of a vehicle according to an embodiment of the present invention is shown. Referring to FIG. 2, at step S100, a prototype driver information system for a usability evaluation is formed through the driver information system realization portion 10.

Then, at step S101, initial learning is performed by a driver's selection of an initial learning mode while a vehicle to which the usability evaluation system is installed stops. A driver can recognize information service functions through the initial learning.

Subsequently, at step S102, analyses of the body signal and the driver's manipulation behavior while a driver operates various functions of the realized driver information system while driving the vehicle is performed, on the basis of the information of the photographing portion 30 and the body signal detecting portion 40. That is, the user's manipulation reaction data and the body signals are detected. The detection of the body signals while various functions of the realized driver information system are being performed is synchronized to an operation of the application program for realizing the driver information system.

Subsequently, at step S103, a driver's objective evaluation data are detected and an objective usability is evaluated through such data. That is, the user's objective evaluation data is obtained.

The user's manipulation reaction data, the body signal, and the driver's objective evaluation data are converted on the basis of a query of the database 50, and the converted data are automatically stored to the database 50. The data stored in the database 50 can be linked to a statistical analysis tool through an open database connectivity (ODBC) function of the database 50 at step S104.

In addition, at step S105, analysis results are obtained by synthesizing usability evaluation data for the prototype driver information system. Then, at step S106, an improved prototype is formed on the basis of the obtained analysis results. It is determined whether to perform again the usability evaluation at step S107. If the usability evaluation is requested, the procedure goes to step S101, and otherwise the procedure ends. If the usability evaluations for the prototype are repeatedly performed, a feedback cycle for continuous update is realized.

In the real-time and multi-dimensional usability evaluation system according to an embodiment of the present invention, data for a usability evaluation are automatically or manually collected through the detecting devices and the application/evaluation program, and the analysis results for the collected data are reflected to a re-design of the prototype, so that a performance of the user interface of the driver information system can be gradually improved and a user-oriented design method can be realized.

According to an embodiment of the present invention, a usability evaluation of a driver information system for a vehicle can be performed real-time and multi-dimensionally, dimensionally, a time for collecting and analyzing data for a usability evaluation can be reduced by developing an application program, and an economical loss and a time loss for manufacturing a real prototype can be reduced.

Continuous improvements of the usability of the driver information system can be possible by repeatedly performing the design process and the evaluation process, and in particular, a systematic and multi-dimensional approach for an improvement of the usability in a multi-task environment of a vehicle in which at least two works are simultaneously performed and in a critical operation environment of a vehicle can be realized.

In addition, because evaluations are automatically performed while a driver operates the driver information system and various services at any time when the driver wants, more reliable data for a usability evaluation can be obtained than by a conventional test method in which a specific work may be performed in a specific test environment.

Although embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A usability evaluation system for a driver information system, comprising: a database;
a driver information system realization portion for realizing a prototype driver information system and detecting a user's manipulation reaction data while a user operates the driver information system, the driver information system realization portion converting the detected user's manipulation reaction data to data for a usability evaluation and automatically storing the converted data in the database; and
a user's evaluation data gathering portion for gathering a user's objective evaluation data for the realized driver information system, the user's evaluation data gathering portion converting the gathered user's objective evaluation data to data for a usability evaluation and automatically storing the converted data to the database.

2. The usability evaluation system of claim 1, wherein the driver information system realization portion comprises:
a computer for executing an application program that provides a user interface for realizing the driver information system;
an output device for outputting the user interface provided by the application program; and
an input device for providing functions for operating the outputted user interface.

3. The usability evaluation system of claim 2, wherein the driver information system realization portion further comprises:
a global positioning system (GPS) receiver configured to be linked to a position information providing service of the application program;
a wireless communication terminal;
a voice input/output device for a voice interface of the application program; and
a voice recognition device for recognizing a user's voice received from the voice input/output device.

4. The usability evaluation system of claim 1, further comprising:
a photographing part for photographing a user's manipulation of the driver information system to obtain data for analyzing a user's action for manipulating the driver information system; and
a body signal detecting part for detecting a body signal information of the user while operating the driver information system.

5. The usability evaluation system of claim 4, wherein the photographing part photographs a user of the driver information system, the driver information system, and a vehicle front portion.

6. The usability evaluation system of claim of 4, wherein the body signal detecting part detects a brain wave of the user of the driver information system, eyeball movement of the user, and heart rate of the user.

7. The usability evaluation system of claim 1, further comprising:
a photographing part for photographing a user's manipulation of the driver information system to obtain data for analyzing a user's action for manipulating the driver information system; and
a body signal detecting part linked to the application to operate cooperatively therewith and detecting a body signal information of the user while operating the driver information system.

8. The usability evaluation system of claim 1, wherein the user's objective evaluation data comprises:
data for a user's mental workload while operating the realized driver information system;
data for a user's complaint and claim for the realized driver information system;
data for a user's emotional feeling for the realized driver information system; and
data for a user's requirement for a new design or a new function.

9. A usability evaluation system for a driver information system, comprising:
a database;
a driver information system realization portion configured to:
detect a user's manipulation of the driver information system;
convert the user's manipulation to data for a usability evaluation; and
store the converted data in the database; and
a user's evaluation data gathering portion configured to:
gather a user's objective evaluation data for the driver information system;
convert the gathered user's objective evaluation data to data for a usability evaluation; and
store the converted data in the database.

10. The usability evaluation system of claim 9, wherein the driver information system realization portion comprises:
a computer for executing an application program that provides a user interface for realizing the driver information system;
an output device for outputting the user interface provided by the application program; and
an input device for providing functions for operating the outputted user interface.

11. The usability evaluation system of claim 9, wherein the driver information system realization portion further comprises:
a global positioning system (GPS) receiver configured to be linked to a position information providing service of the application program;
a wireless communication terminal for wireless communication;
a voice input/output device for a voice interface of the application program; and
a voice recognition device for recognizing a user's voice received from the voice input/output device.

12. The usability evaluation system of claim 9, further comprising:
a photographing part for photographing a user's manipulation of the driver information system; and
a body signal detecting part for detecting a body signal information of the user while operating the driver information system.

13. The usability evaluation system of claim 12, wherein the photographing part photographs a user of the driver information system, the driver information system, and a vehicle front portion.

14. The usability evaluation system of claim of 12, wherein the body signal detecting part detects brain waves of the user of the driver information system, eyeball movement of the user, and a heart rate of the user.

15. The usability evaluation system of claim 9, further comprising:
a photographing part for photographing a user's action for manipulating the driver information system and the driver information system to obtain data for analyzing a user's action for manipulating the driver information system; and
a body signal detecting part linked to the application to operate cooperatively therewith and detecting a body signal information of the user while operating the driver information system.

16. The usability evaluation system of claim 9, wherein the user's objective evaluation data comprises:
data for a user's mental workload while operating the realized driver information system;
data for a user's complaint and claim for the realized driver information system;
data for a user's emotional feeling for the realized driver information system; and
data for a user's requirement for a new design or a new function.
